(19) United States
(12) Patent Application Publication
(10) Pub. No.: US 2026/0346087 A1
(43) Pub. Date: Nov. 5, 2026

(54) An Improved Exercise Bike

(71) Applicant: Muoverti Limited, Weybridge (GB)

(72) Inventors: Chris Staunton, Weybridge (GB); Alex Caccia, Weybridge (GB); Andy Hibberd, Weybridge (GB)

(21) Appl. No.: 18/997,655

(22) PCT Filed: Jul. 13, 2023
(86) PCT No.: PCT/GB2023/051842

§ 371 Date: Jan. 22, 2025

(30) Foreign Application Priority Data
Jul. 22, 2022 (GB) 2210791.6

(51) Int. Cl. A63B 22/00; A63B 22/06

(52) U.S. Cl. CPC A63B 22/0046; A63B 2022/0641

(57) ABSTRACT

An exercise bike comprising: a base; a frame; and a steering stem rotatably mounted to the frame to allow rotation of the steering stem, relative to the frame, about a steering axis of the stem by a user, wherein the frame is rotatably mounted to the base to allow rotation of the frame, relative to the base, about a tilt axis, wherein a resilient member is provided between the steering stem and the base, the resilient member configured such that: when the frame or steering stem is rotated in a direction, relative to its respective rotational axis, the other of the frame or steering stem is urged to rotate in the same direction, relative to its respective rotational axis.

### FIELD

The present invention relates to an improved exercise bike.

### BACKGROUND

Recent developments in exercise bikes seek to simulate the tilting movements which are experienced by the rider of a conventional bicycle as it tilts to the left or right during turns and/or through the application of power to the pedals. Additionally, the control inputs to an exercise bike may be transferred to a video game or the like, which a user may enjoy whilst they exercise.

This disclosure seeks to improve upon existing exercise bikes.

### BRIEF DESCRIPTION OF THE INVENTION

The present invention provides an exercise bike comprising:
a base;
a frame; and
a steering stem rotatably mounted to the frame to allow rotation of the steering stem, relative to the frame, about a steering axis of the stem by a user,
   wherein the frame is rotatably mounted to the base to allow rotation of the frame, relative to the base, about a tilt axis,
   wherein a resilient member is provided between the steering stem and the base, the resilient member configured such that:
   when the frame or steering stem is rotated in a direction, relative to its respective rotational axis, the other of the frame or steering stem is urged to rotate in the same direction, relative to its respective rotational axis.

In at least one embodiment the steering stem is provided with an arm which projects substantially rearwardly from the steering stem and the resilient member is connected between the arm and the base.

The present invention provides an exercise bike comprising:
a base;
a frame; and
a steering stem rotatably mounted to the frame to allow rotation of the steering stem, relative to the frame, about a steering axis of the stem by a user,
   wherein the frame is rotatably mounted to the base to allow rotation of the frame, relative to the base, about a tilt axis,
   wherein the steering stem is provided with an arm which projects substantially rearwardly from the steering stem;
   wherein a resilient member is connected between the arm and the base.

In at least one embodiment the resilient member is further configured to urge the steering stem substantially into rotational alignment with a predetermined point on the base.

In at least one embodiment a resilient mounting is provided between the frame and the base.

In at least one embodiment the resilient member is configured to bias the frame towards a substantially upright position relative to the base.

In at least one embodiment the resilient mounting is configured to bias the frame towards a substantially upright position relative to the base.

In at least one embodiment the resilient mounting and resilient member, together, are configured to bias the frame towards a substantially upright position relative to the base.

In at least one embodiment the resiliency of the resilient member is adjustable.

In at least one embodiment the resiliency of the resilient mounting is adjustable.

In at least one embodiment the resilient member and the steering axis of the steering stem are angled with respect to the vertical; or
the resilient member and the steering axis of the steering stem are substantially vertical.

In at least one embodiment the resilient member is substantially parallel to the steering axis of the steering stem.

In at least one embodiment an exercise bike further comprising a drive mechanism for operation by a user.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a side view of an exercise bike, embodying the present disclosure;

FIG. 2 is a front view of an exercise bike, embodying the present disclosure;

FIG. 3 is a substantially top-down view of an exercise bike as viewing from a direction parallel to the longitudinal axis of the steering stem, embodying the present disclosure;

FIG. 4 is a detailed perspective view of the steering arrangement of an exercise bike in a frame tilted position, embodying the present disclosure;

FIG. 5 is a partial rear view of the steering arrangement of an exercise bike in a frame tilted position, embodying the present disclosure;

### DETAILED DESCRIPTION OF THE DISCLOSURE

Existing exercise bikes have sought to introduce a realistic pairing of physical tilting and steering, so far to limited effect, due to the seemingly unnatural consequence that tilting the bike has on the steering position as well as the effect that steering the bike has on the tilt position.

It is to be understood that when the user of an exercise bike is tilting the frame over to the right and they wish to level the bike (to restore the bike to an upright/straight ahead position), the natural next step for a user is to turn the handlebar to the left in an attempt to rotate the frame to the left. This is the natural next step because whilst sitting stationary on an exercise bike that is leaning to the right, moving left from that position will of course restore the frame to the vertical position.

The inventor previously proposed the system disclosed in GB2520677. This disclosure detailed a system comprising a fixed riser which connects via a resilient cord to an adjusting mechanism that projects forwardly from a steering stem. The steering stem is mounted within a head tube of a conventional bicycle frame and the frame is pivotally mounted to a base. It has become apparent to the inventor, after various trials and conducting developmental work, that this arrangement is limited in its functionality and offers an experience to the user which is counterintuitive.

The teaching of GB2520677 is such that if the frame is tilted in a direction abouts its axis, the effect of the forward projecting adjusting mechanism is such that the resilient cord will urge the steering stem to rotate about its axis in a second direction. What this means is that if the frame is tilted to the left (as viewed by a user from the seat) then the handlebar (via the steering stem) is rotated to the right, that is the right-hand end of the handlebar is moved toward the rear of the exercise bike.

In use, therefore, the user must rotate the handlebar toward the direction of the lean to urge the frame back to the level position, rather than turning the handlebar in a direction away from the lean. This is counterintuitive and detracts from the user experience.

This problem is pronounced further when the avatar of a video game is considered. If the user is controlling an avatar on screen using the movements of the bike frame and the handlebar, it is counterintuitive for them to have to rotate the handlebar in a direction opposite that of the desired input direction to the avatar.

The disclosures of GB2520677 do indeed provide a relationship between the movement of the frame and the handlebar, but it is not ideal nor optimal. Inventor has therefore revisited the teachings of GB2520677 and sought to improve upon them with the present disclosure.

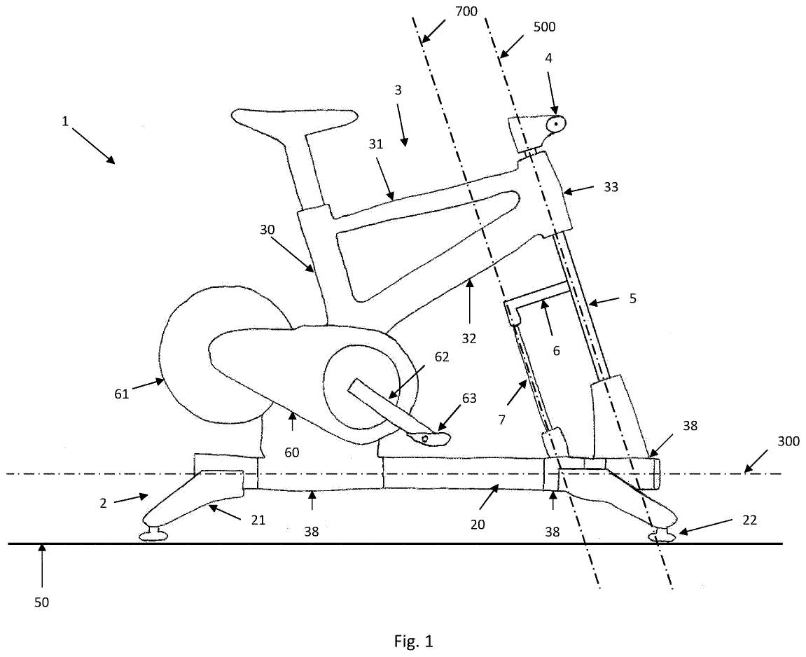

FIG. 1 schematically illustrates an exercise bike 1 for static use. The exercise bike 1 is configured to allow a user to exercise. The exercise bike 1 may define a longitudinal direction parallel to a user's general direction of travel if the exercise bike 1 were a conventional bike, a width which is perpendicular to the longitudinal direction and substantially horizontal, and a height perpendicular to both the longitudinal direction and the width.

Additionally, the longitudinal direction defines a front and a rear of the exercise bike 1. The front is taken to be the end of the exercise bike 1 that, when in use, is substantially in front of the user. The rear is taken to be the end of the exercise bike 1 that, when in use, is substantially behind the user. The forward direction is thus defined as heading in the direction of the front of the exercise bike 1. A rearward direction is thus defined as heading in the direction of the rear of the exercise bike 1. Left and right directions are also defined based on the perspective of the user while using the exercise bike 1.

### Base

The exercise bike 1 comprises a base 2 and a frame 3. The base 2 is positioned in the lower portion of the exercise bike 1. The base 2 is configured to provide a sturdy platform capable of supporting the weight of the exercise bike 1 and a user in use. The base 2 rests on a floor 50 of the area in which the exercise bike 1 is used. The base 2 may comprise at least one central longitudinal bar 20 in use to support the frame 3. The longitudinal bar 20 may not be a single bar and may be a plurality of bars. The at least one bar 20 may be of square or circular cross-section or any other suitable cross-section. In a condition where the floor 50 is substantially flat, the base 2 may provide a plane of support which is substantially parallel to the floor 50 and substantially horizontal.

### Frame

The frame 3 may comprise a seat tube 30, top tube 31 and down tube 32. These tubes 30, 31, 32 may be joined so as to substantially define a triangle, as is conventional. It is to be understood that several types of frame are suitable for use with the invention and that the previously mentioned conventional frame is preferable but not essential to the disclosure. The frame 3 may be of any of the following varieties: step-through, cantilever, recumbent, prone, cross, truss, monocoque, folding or tandem.

The frame 3 is rotatably mounted to the base 2. The frame 3 may be rotatably mounted to the longitudinal bar 20 of the base 2. The frame 3 may be rigidly mounted to the longitudinal bar 20 of the base 2, wherein the longitudinal bar 20 is rotatable within at least one mounting (not illustrated) to the at least one leg 21. The frame 3 may further comprise at least one mechanical stop (not illustrated) which allows the frame 3 to rotate relative to the base 2 only within a predetermined range. The predetermined range may be 30°in either direction from a neutral position (defined below). The at least one mechanical stop may be part of the base 2 and/or frame 3. The at least one mechanical stop may comprise at least one buffer mounted to the base 2 and at least one tab mounted to the frame 3 and configured to rotate with the frame 3 within the range determined by the placement of the at least one buffer.

### Tilt axis

The tilt axis 300 of the frame 3 relative to the base 2 may be parallel to the longitudinal direction of the exercise bike 1 and is positioned in the lower portion of the exercise bike 1. The tilt axis 300 of the frame 3 may not be horizontal. The tilt axis 300 of the frame 3 may be substantially coaxial with the longitudinal axis of the central longitudinal bar 20 of the base 2.

### Tilt Axis Rotation

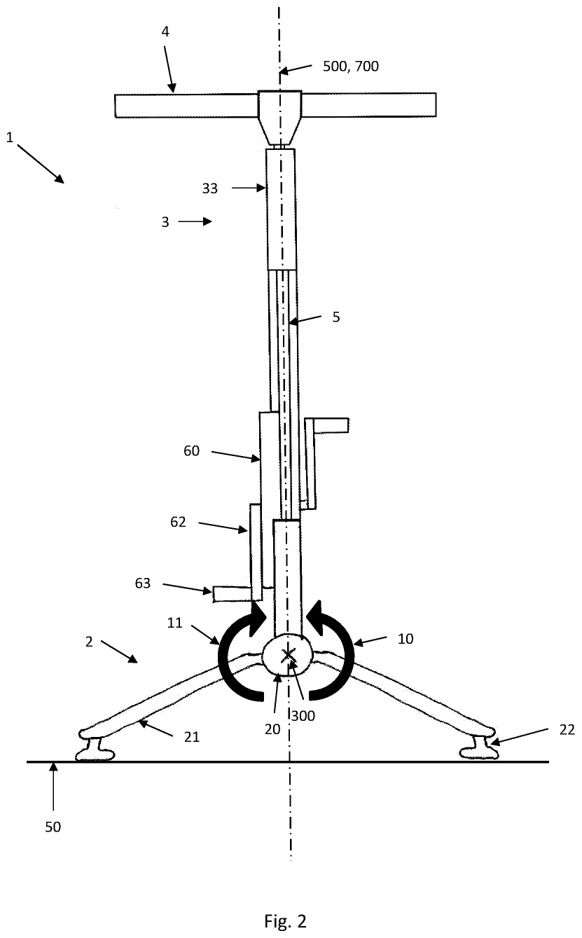

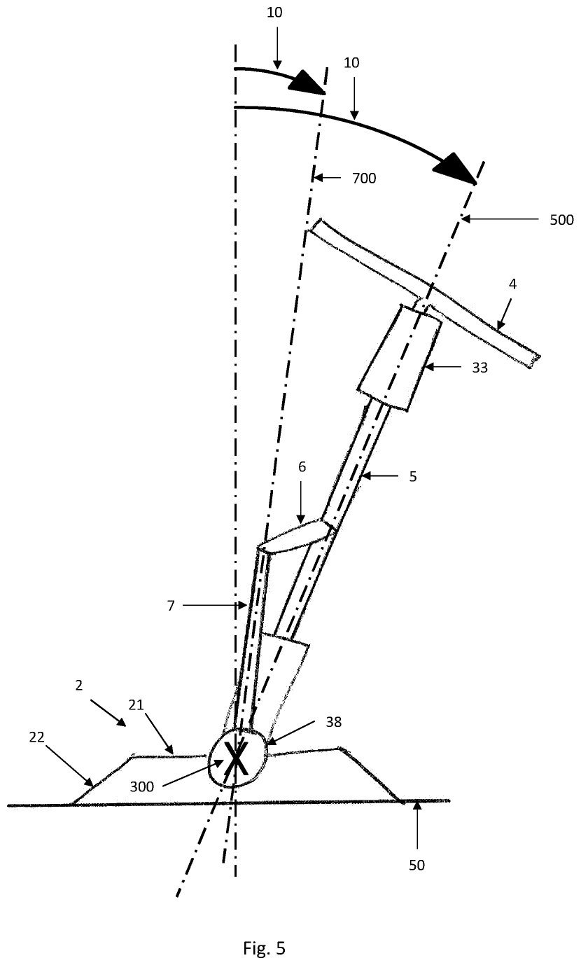

An example of the tilt axis 300 location is depicted in FIGS. 1, 3 and 4 as a dashed line. An example of the tilt axis 300 location is depicted in FIGS. 2 and 5 as a crosshair. FIG. 2 depicts the exercise bike 1 as viewed from the front, looking rearward. Rotation directions about the tilt axis 300 are shown in FIG. 2 which is a view of the front of the exercise bike 1, from the front. The direction of rotation about the tilt axis 300 may be defined as viewed by the user, while using the exercise bike 1. Tilting the frame 3 about the tilt axis 300 in an anti-clockwise 11 direction may be equivalent to tilting the frame 3 to the left. Tilting the frame 3 about the tilt axis 300 in a clockwise 10 direction may be equivalent to tilting the frame 3 to the right.

### Head Tube

The frame 3 may further comprise a head tube 33. The head tube 33 may be positioned toward the top and front of the frame 3, as is conventional. The head tube 33 may have a longitudinal axis which is inclined to the vertical when the frame 3 is in the neutral position (described below). The head tube 33 may be inclined by 0-45 degrees to the vertical when the frame 3 is in the neutral position. The head tube 33 may be connected to or between the top tube 31 and/or down tube 32. The head tube 33 may consist of more than one individual tube element aligned coaxially along the steering axis 500 (defined below). The individual tube elements may be separate.

### Handlebar

With reference to the figures, the handlebar 4 is depicted as a straight bar for the ease of illustration. The depicted handlebar 4 can be considered as the central elongate part of any appropriate handlebar 4. The handlebar 4 of the exercise bike 1 may be mounted to the frame 3.

The handlebar 4 may be mounted to the steering stem 5. The handlebar 4 is intended to give the user a sturdy handle to hold while they operate the exercise bike 1 as well as to offer a familiar riding position relative to a conventional bike. The handlebar 4 may be formed from a single tube which has been shaped to provide grip portions which are within comfortable reach of the user. The handlebar 4 may be any of the following varieties: dropped, bullhorn, riser, flat, aero or BMX. The handlebar 4 may comprise a tube with grip sections at each end for the user to hold. The grips may be formed of a slip resistant material. The grips may be further configured to be resistant to sweat from the user's hands, and remain slip resistant when wet.

The handlebar 4 may further comprise a selection of control buttons and levers (not illustrated) configured to operate various mechanical and/or electronic features. The handlebar 4 may comprise at least one mechanical stop (not illustrated) which allows the handlebar 4 to rotate relative to the frame 3 about the steering axis 500 only within a predetermined range. The predetermined range may be 45° in any direction from a position perpendicular to the neutral position of the frame 3. The at least one mechanical stop may be part of the frame 3 and/or handlebar 4. The at least one mechanical stop may comprise at least one buffer mounted to the frame 3 and at least one tab mounted to the handlebar 4 and configured to rotate with the handlebar 4 within the range determined by the placement of the at least one buffer.

### Steering Stem

The steering stem 5 is rotatably mounted to the frame 3. The steering stem 5 is rotatable, relative to the frame 3, about a steering axis 500 (defined below). The steering stem 5 and frame 3 may be joined via one or more bearings. The one or more bearings may be of the tapered, roller ball, cartridge, or any other suitable type. The steering stem 5 may be rotatably received in the head tube 33 of the frame 3. The steering stem 5 may have a longitudinal axis which is coaxial with the longitudinal axis of the head tube 33. The steering stem 5 and head tube 33 may be joined via one or more bearings. The one or more bearings may be of the tapered, roller ball, cartridge, or any other suitable type.

The handlebar 4 may be mounted to the steering stem 5. The handlebar 4 may be mounted by means of a clamp with one or more bolts received in the steering stem 5. The handlebar 4 may be mounted such that the user can apply a torque to the steering stem 5 by rotating the handlebar 4. The user may apply a force to the handlebar 4 which in turn applies a torque to the steering stem 5, the handlebar 4 acting as a lever.

### Steering Axis

The steering axis 500 of the steering stem 5 may be substantially vertical or, as shown and is conventional, at an angle to the vertical. The steering axis 500 may be coaxial with the longitudinal axis of the steering stem 5. The steering axis 500 may be coaxial with the longitudinal axis of the head tube 33. The steering axis 500 may be substantially perpendicular to the tilt axis 300 of the frame 3. The steering axis 500 may be inclined from the vertical. The steering axis 500 may be inclined from the vertical by 0-45 degrees.

### Steering Axis Rotation

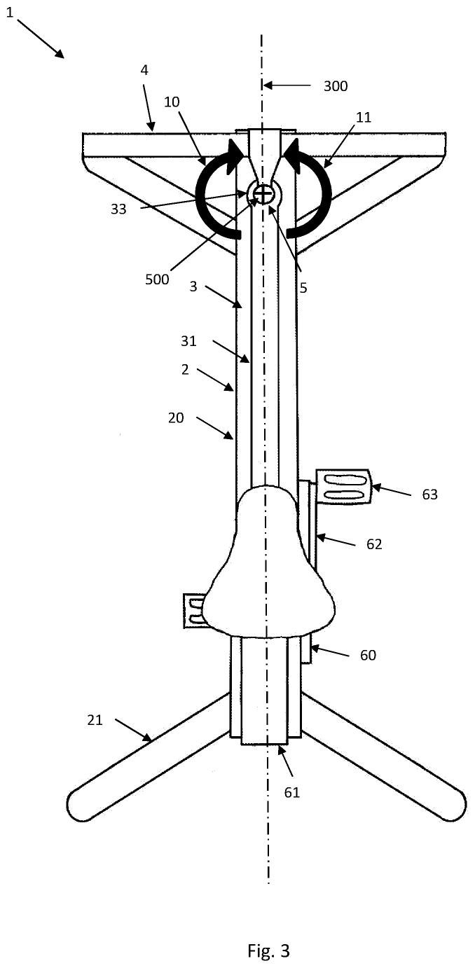

Rotation direction about the steering axis 500 may be defined as viewed by the user while using the exercise bike 1. FIG. 3 shows the exercise bike 1 as viewed from above, specifically looking along the steering axis 500 (best illustrated by the steering axis 500 dashed line of FIG. 1), and not the vertical direction. The steering axis 500 is shown as a crosshair positioned rearward of the handlebar 4 and coaxial with the head tube 33. In this depiction the steering axis 500 extends into and out of the image. Rotation directions about the steering axis 500 are illustrated in FIG. 3. In use, clockwise 10 movement of the steering stem 5 may be induced by moving the right hand side of the handlebar 4 toward the rear of the exercise bike 1. In use, anti-clockwise 11 movement of the steering stem 5 may be induced by moving the left hand side of the handlebar 4 toward the rear of the exercise bike 1.

### Plane of the Frame

The frame 3 defines a primary plane which shall be referred to as the plane (not illustrated) of the frame. This plane may be defined as the plane which substantially intersects the central axes of the tubes 30, 31 and 32 (and 33) of the frame 3. The plane of the frame may be further defined as the plane which a user straddles with their legs when operating the exercise bike 1, and further that the user's torso is symmetrically intersected by the plane. This plane may further define the meeting point of a left and right side of the exercise bike 1, any turns or rotations can be referenced to these.

Generally, in use, the frame 3 is arranged such that the plane is substantially vertical and/or substantially perpendicular to the plane of the base 2.

### Neutral Position of the Frame

The neutral position of the frame 3 is established as a position of the frame 3 relative to the base 2. The neutral position of the frame 3 may be achieved when the previously mentioned plane of the frame is perpendicular to that of the base 2 (i.e. substantially vertical). The neutral position of the frame 3 may be considered as a position from which positive or negative, clockwise 10 or anti-clockwise 11 rotations of the frame 3 are measured. The neutral position of the frame 3 may be represented by the position a conventional bike frame would find itself in when being ridden straight ahead on level ground. The neutral position of the frame 3 is illustrated in FIGS. 1, 2 and 3. When in the neutral position, the steering axis 500 may be substantially parallel with the vertical.

### Neutral Position of Steering Stem

The steering stem 5 may have a neutral position. The neutral position of the steering stem 5 may be achieved when the frame 3 is in its neutral position and the handlebar 4 is positioned substantially perpendicular to the plane of the frame. The neutral position of the steering stem 5 may be achieved when the steering stem 5 is substantially in rotational alignment with a predetermined point on the base 2.

### Arm

An arm 6 is provided on the steering stem 5. The arm 6 projects from the steering stem 5 substantially rearwardly. The arm 6 may project from the steering stem 5 in a direction substantially perpendicular to the steering axis 500. In the event that the steering axis 500 is not vertical, the arm 6 may project from the steering stem 5 at a non-perpendicular angle, such that the arm is substantially horizontal. The arm 6 may be fixed to the steering stem 5 at a point in close proximity to the head tube 33 and down tube 32 of the frame 3. The arm 6 may extend substantially toward the frame 3 of the exercise bike 1 from the steering stem 5. The arm 6 may be formed as a single component with the steering stem 5. The direction the arm 6 extends provides the advantage of a more compact exercise bike. The arm 6 may be fixed to the steering stem 5 by any suitable means. The arm 6 may be rigid or substantially rigid. The arm 6 may be rigidly fixed to the steering stem 5 such that it may transfer forces to and/or from the steering stem 5.

### Resilient Member

A resilient member 7 may be connected between the base 2 and the steering stem 5. The resilient member 7 may be connected between the arm 6 and the base 2. The resilient member 7 is configured to urge the steering stem 5 substantially into rotational alignment with a predetermined point on the base 2. The resilient member 7 may be configured to urge the steering stem 5 substantially into rotational alignment with a predetermined point on the frame 3. The resilient member 7 may be configured to bias the frame 3 toward a substantially upright/vertical position relative to the base. The resilient member 7 may be permanently attached to the arm 6 and base 2. The resilient member 7 may be pivotally attached to the arm 6 and or base 2. The resilient member 7 may be received by the base 2 via a slot (not illustrated). The slot may offer restriction of movement of the resilient member 7 in all but one degree of freedom. The slot may offer restriction of movement of the resilient member 7 in more than one degree of freedom. The resilient member 7 may be pivotally attached to the arm 6. The resilient member 7 may be removably attached to the arm 6 such that it may be replaced. The resilient member 7 may be a consumable part that requires replacement or maintenance. The resilient member 7 may be substantially elongate and may define a longitudinal axis 700 of the resilient member 7. The longitudinal axis 700 of the resilient member 7 may be substantially parallel to the steering axis 500 (as depicted in FIG. 1). The longitudinal axis 700 of the resilient member 7 may be angled with respect to the vertical. The longitudinal axis 700 of the resilient member 7 may be substantially vertical.

The resilient member 7 may be formed as a single component with the arm 6. The resilient member 7 may be formed as a single component with the arm 6 and steering stem 5. The resilient member 7 may be configured to bias the steering stem 5 toward the neutral position of the steering stem 5. The resilient member 7 may comprise a spring. The resilient member 7 may be formed of a polymer with elastomeric properties. The resilient member 7 may further comprise a means of adjustment of the resilient member 7. In use the adjustment may be configurable by a user to configure the resilient member 7. The resilient member 7 may further comprise an adjustment control which can be operated by a user when the exercise bike 1 is in use. The resilient member 7 may be configured to retain elastic potential energy when it is deformed, such that it can release this energy in restoring the steering stem 5 to the neutral position. The resilient member 7 may be configured to urge the frame 2 to its neutral position.

### Resilient Mountings

A resilient frame mounting 38 may be provided between the frame 3 and base 2. This resilient frame mounting 38 may be configured to bias the frame 3 toward the neutral position of the frame 3. The resilient mounting may, together with the resilient member 7, be configured to bias or urge the frame 3 towards a substantially upright and/or substantially vertical position relative to the base 2. The resilient frame mounting 38 may comprise a spring. The resilient frame mounting 38 may be formed of a polymer with elastomeric properties. The resilient frame mounting 38 may further comprise a means of adjustment. In use the adjustment may be configurable by a user to configure the resilient frame mounting 38. The resilient frame mounting 38 may further comprise an adjustment control which can be operated by a user when the exercise bike 1 is in use. The resilient frame mounting 38 may be configured to retain elastic potential energy when it is deformed, such that it can release this energy in restoring the frame 3 to the neutral position of the frame 3. The resilient frame mounting 38 may comprise a plurality of mountings which connect to a plurality of points on the frame 3. The resilient frame mounting may be located substantially beneath the seat tube 30 of the frame 3. A resilient frame mounting 38 may be located at an intersection of the steering stem 5 and the base 2. A resilient frame mounting 38 may also be located at an intersection of the resilient member 7 and the base 2.

### Functionality

In use the frame 3 of the exercise bike 1 may be tilted by a user. The user may induce tilt by transferring their own weight to one side of the frame 3. The user may induce tilt by rotating the steering stem 5. The user may rotate the steering stem 5 via the handlebar 4, the handlebar 4 acting as a lever.

If the frame 3 is tilted by a user, the steering stem 5 is urged to rotate. If the steering stem 5 is rotated by a user, the frame 3 is urged to tilt. If the frame 3 is tilted clockwise 10 by a user about the tilt axis 300, the steering stem 5 may be urged to rotate clockwise 10 about the steering axis 500. If the steering stem 5 is rotated clockwise 10 about the steering axis 500 by a user, the frame 3 may be urged to tilt clockwise 10 about the tilt axis 300. If the frame 3 is tilted anti-clockwise 11 by a user about the tilt axis 300, the steering stem 5 may be urged to rotate anti-clockwise 11 about the steering axis 500. If the steering stem 5 is rotated anti-clockwise 11 about the steering axis 500 by a user, the frame 3 may be urged to tilt anti-clockwise 11 about the tilt axis 300.

In other words, when the frame 3 or steering stem 5 is rotated in a direction, relative to its respective rotational axis, the other of the frame 3 or steering stem 5 is urged to rotate in the same direction, relative to its respective rotational axis.

### Mechanics

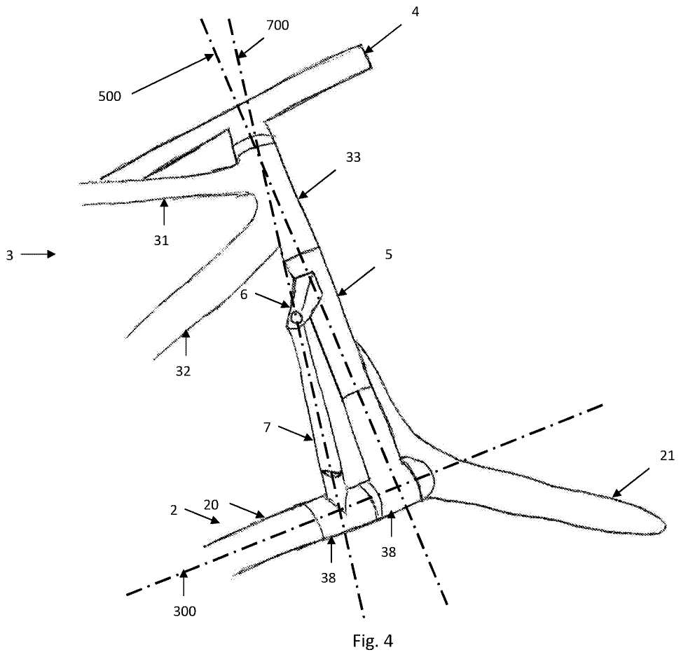

Referring now to FIGS. 4 and 5. The apparatus, in use, can be manipulated by a user into different orientations and combinations of different orientations. That is, the orientation of the frame 3 relative to the base 2, the orientation of the steering stem 5 relative to the frame 3, and the orientation of the resilient member 7.

The operational characteristics of the exercise bike 1 are most easily appreciated with reference to FIG. 4. FIG. 4 will now be described in detail. The frame 3 has rotated anti-clockwise 11 about the tilt axis 300 by approximately 15 degrees from its neutral position. Simultaneously, the resiliency of the resilient frame mounting 38 beneath the resilient member 7 causes the resilient member 7 to remain substantially upright in comparison to the frame 3, or at least tilted to a lesser extent. In FIG. 4, the resilient member 7 is inclined at around 10 degrees to the vertical. The resiliency of the resilient frame mounting 38 has the effect of retaining the resilient member 7 which acts on the arm 6, and in turn the steering stem 5, causing the steering stem 5 to rotate anti-clockwise 11 about the steering axis 500. The handlebar 4 depicted in FIG. 4 is therefore turned to the left, that is, with the left-hand end of the handlebar 4 moved substantially toward the rear of the exercise bike 1.

From this position the present disclosure offers an advantage over GB2520677, as described above. For example, if the user desired to return the frame 3 to the neutral position, or even to rotate the frame 3 in the clockwise 10 direction, relative to the tilt axis 300, by any amount, they have two options. Firstly, the user could transfer their body weight to the right and in doing so oppose the resilience of the resilient frame mountings 38 and the resilient member 7. This would urge the frame 3 to rotate clockwise 10. Secondly, the user could rotate the steering stem 5 (which may be achieved by rotating the handlebar 4) in a clockwise 10 direction. This would cause the end of the arm 6 where the resilient member 7 connects to move to the left (as viewed in FIG. 4) and as a result apply tension to the resilient member 7. The tension within the resilient member 7 would act on the arm 6 to cause the frame to be urged to the right, or to rotate clockwise 10 toward the neutral position. The user could apply both of the above methods, steering input and leaning (transferring body weight) to achieve the desired effect.

With respect to the above example read with reference to FIG. 4, it is to be understood that the given example is not exclusive to scenarios where the frame 3 has initially tilted anti-clockwise 11. Rather, the above still applies wherein any reference to right/left or clockwise 10/anti-clockwise 11 is opposed.

The above teaching is advantageous over existing exercise bikes, due to the inherent and intuitive relationship between the steering input and the frame rotation direction. The present disclosure is therefore preferable in terms of usability and intuitiveness.

Referring now to FIG. 5, the above characteristics are illustrated from a different perspective. FIG. 5 shows the steering arrangement of the exercise bike 1 only. In this scenario the frame 3 has tilted around 25 degrees in the clockwise 10 direction. Per the example of FIG. 4, the handlebar 4 and steering stem 5 have rotated relative to the steering axis 500, also in the clockwise 10 direction. This is clearly the case as the arm 6 can be seen to project from the steering stem 5 toward the left (as viewed in FIG. 5). The resilient member 7 has caused the steering stem 5 to rotate to its current position due to its connection to the resilient frame mounting 38. FIG. 5 illustrates the relative difference in the angles of the steering axis 500 and the longitudinal axis 700 of the resilient member 7 to the vertical when in the tilted position.

### Removably Mounted Handlebar

The handlebar 4 of the exercise bike 1 may be removably mounted to the frame 3. The handlebar 4 may be mounted by a releasable means so that the user can interchange the handlebar 4. The handlebar 4 may be removably mounted in such a way that its height and reach can be adjusted to the user's preference. The handlebar 4 may be interchangeable with various types of handlebar such as dropped, bullhorn, riser, flat, aero or BMX. The handlebar 4 mounting means may be adjustable to accommodate differing diameter handlebars. The handlebar 4 may be replaced with handlebars from a user's road going bike, such that they can enjoy the familiarity of these on the exercise bike 1.

### Drive Mechanism

The exercise bike 1 may further comprise a drive mechanism 60. The exercise bike 1 may further comprise a motor 61. The exercise bike 1 may further comprise a drive mechanism 60 with a crank 62 and at least one pedal 63. The crank 62 may be configured to rotate about an axis perpendicular to the plane of the frame, and the crank 62 may be positioned substantially in a plane offset from the plane of the frame. A pedal 63 may be provided on each side of the frame 3, each connected to the crank 62. A chain or other connecting means (not illustrated) may link the crank 62 to the motor 61. The motor 61 may be configured to provide resistance to motion of the drive mechanism. The motor 61 may be monitored by a tachometer or other speed sensing means. The speed sensing means may provide a data signal containing the current speed of the motor 61 to a processor. The chain or other connecting means may further comprise a means for configuring the ratio between rotations of the crank 62 and rotations of the motor 61, such as a gear set.

### Output to Graphic

Various parameters of the exercise bike 1 may be detected by sensors (not illustrated). These detections may be passed on to a processor which performs a level of processing on the raw detections. An output from the processor may be configured for controlling a graphic. The output may be configured to control a simulation program, video game and/or other media.

### Legs and Feet

The base 2 may further comprise at least one leg 21, which may be formed of similar material to the at least one longitudinal bar 20. The at least one leg 21 may be mounted to the longitudinal bar (s) 20 and configured to extend at least laterally from the bar 20. The at least one leg 21 may be configured to extend out from the longitudinal bar 20 in order to increase the footprint area of the exercise bike 1. The footprint of the exercise bike 1 may be configured to provide an adequate support footprint for the exercise bike 1 in use with the additional weight of a user, such that if the centre of mass of the exercise bike 1 changes as the user tilts the frame 3 and/or shifts their mass, the base 2 prevents the exercise bike 1 from toppling. The base 2 of the exercise bike 1 may be configured to adequately support users of various different sizes and weights. The base 2 may be substantially wider and longer than it is tall, with reference to the directions set out above for the frame 3 and according to the footprint mentioned previously. The at least one leg 21 may provide a fitting for at least one foot 22. The at least one foot 22 is configured to rest on the floor 50. The at least one foot 22 may provide a form of adjustment to account for discrepancies in the floor 50 level. The at least one foot 22 may be formed from a material which offers resistance to slip between the base 2 and floor 50 such as rubber. Alternatively, the at least one leg 21 may be configured to include a foot as opposed to providing a fitting. Generally, the base 2 (comprising the longitudinal bar 20 and any legs 21) extends in a plane which is substantially horizontal in use, parallel to the surface of the floor.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. An exercise bike comprising:
a base;
a frame; and
a steering stem rotatably mounted to the frame to allow rotation of the steering stem, relative to the frame, about a steering axis of the stem by a user,
wherein the frame is rotatably mounted to the base to allow rotation of the frame, relative to the base, about a tilt axis,
wherein a resilient member is provided between the steering stem and the base, the resilient member configured such that:
when the frame or steering stem is rotated in a direction, relative to its respective rotational axis, the other of the frame or steering stem is urged to rotate in the same direction, relative to its respective rotational axis.

2. The exercise bike of claim 1, wherein, the steering stem is provided with an arm which projects substantially rearwardly from the steering stem and the resilient member is connected between the arm and the base.

3. An exercise bike comprising:
a base;
a frame; and
a steering stem rotatably mounted to the frame to allow rotation of the steering stem, relative to the frame, about a steering axis of the stem by a user,
wherein the frame is rotatably mounted to the base to allow rotation of the frame, relative to the base, about a tilt axis,
wherein the steering stem is provided with an arm which projects substantially rearwardly from the steering stem;
wherein a resilient member is connected between the arm and the base.

4. The exercise bike of claim 1, wherein the resilient member is further configured to urge the steering stem substantially into rotational alignment with a predetermined point on the base.

5. The exercise bike of claim 1, wherein a resilient mounting is provided between the frame and the base.

6. The exercise bike of claim 1, wherein the resilient member is configured to bias the frame towards a substantially upright position relative to the base.

7. The exercise bike of claim 5, wherein the resilient mounting is configured to bias the frame towards a substantially upright position relative to the base.

8. The exercise bike of claim 5, wherein the resilient mounting and resilient member, together, are configured to bias the frame towards a substantially upright position relative to the base.

9. The exercise bike of claim 1, wherein the resiliency of the resilient member is adjustable.

10. The exercise bike of claim 5, wherein the resiliency of the resilient mounting is adjustable.

11. The exercise bike of claim 1, wherein the resilient member and the steering axis of the steering stem are angled with respect to the vertical; or
wherein the resilient member and the steering axis of the steering stem are substantially vertical.

12. The exercise bike of claim 1, wherein the resilient member is substantially parallel to the steering axis of the steering stem.

13. An exercise bike according to claim 1, further comprising a drive mechanism for operation by a user.

14. The exercise bike of claim 3, wherein the resilient member is further configured to urge the steering stem substantially into rotational alignment with a predetermined point on the base.

15. The exercise bike of claim 3, wherein the resilient member is configured to bias the frame towards a substantially upright position relative to the base.

16. The exercise bike of claim 3, wherein the resiliency of the resilient member is adjustable.

17. The exercise bike of claim 3, wherein the resilient member and the steering axis of the steering stem are angled with respect to the vertical; or wherein the resilient member and the steering axis of the steering stem are substantially vertical.

18. The exercise bike of claim 3, wherein the resilient member is substantially parallel to the steering axis of the steering stem.

19. An exercise bike according to claim 3, further comprising a drive mechanism for operation by a user.
